(19) United States
(12) Patent Application Publication
(10) Pub. No.: US 2015/0006478 A1
(43) Pub. Date: Jan. 1, 2015

(54) REPLICATED DATABASE USING ONE SIDED RDMA

(71) Applicant: Silicon Graphics International Corp., Milpitas, CA (US)

(72) Inventors: Michael Andrew Raymond, Eagan, MN (US); Lance Evans, Boulder, CO (US)

(73) Assignee: Silicon Graphics International Corp., Milpitas, CA (US)

(21) Appl. No.: 13/931,790

(22) Filed: Jun. 28, 2013

(51) Int. Cl. G06F 17/30

(52) U.S. Cl. CPC G06F 17/30575
USPC 707/610; 707/696

(57) ABSTRACT

This innovation provides a method for a networked and replicated database management system (DBMS) using only one-sided remote direct memory access (RDMA). Replicated databases retain some access to the stored data in the face of server failure. In the prior state of the art, after the software in the DBMS on one of the servers acted on a client's request to update the database, it would contact the other replicas of the database and ensure that they had recorded the change, before responding to the client that the transaction was complete. This innovation describes a method whereby the database client directly interacts with each DBMS replica over the network using only RDMA to directly modify the stored data while maintaining the properties of database atomicity and consistency. This method reduces transactional latency by removing any need for the server DBMS software to respond to or forward requests for service.

### BACKGROUND

1. Field of the Invention

The present invention relates to replication of data. In particular, the present invention relates to replication of data using memory to memory transfers.

2. Description of the Prior Art

Replication of data across database servers is a common safeguard for protecting data. Typically, when reading or writing data, a request to perform a data operation is sent from a client to a database. The database receives the request and processes the request. Processing the request in prior art systems may include the database management (DBMS) system taking control of the data access detecting a request on the data, process the request by searching for the data and performing an operation on the data, generating a response, and transmitting the response. With large amounts of data requests, the DBMS handling of data replication related requests can cause latency issues.

Latency in memory access operations can cause database performance to suffer. To ensure that data is available and up to date as quickly as possible, any reduction in latency is highly desirable. What is needed is an improved method of replicating databases in which latency is reduced.

### SUMMARY

The present technology may provide database replication with low latency using one-sided remote direct memory access. A client may communicate with a DMBS spread across more than one server. The database may include one or more collections of data, known as tables. Each table may be composed of one or more memory data blocks of storage. Memory blocks are either in use storing data, or free for later use. In some DBMSs an in-use block is known as a database row.

Each in-use block may be uniquely identified by a descriptor known as a key. Each table may have an index which may be used to find specific data blocks quickly based on their keys. The index structure may also indicate what data blocks are used and unused. To read the data from a table associated with a certain key, the index structure is accessed to find the specific block containing the data referenced by the key.

After the location is determined, the data is retrieved by reading from the block. After the data is retried, the index must be checked again to see if another client stored a new set of data associated with the key in a different block and updated the index to point to the new block.

An embodiment may perform a method for replicating data. A memory location may be allocated in a first database. A remote direct memory access command may be sent from a client to a first database and a second database to write data to the memory location. An index structure for each of the first database and second database may be updated with information regarding the data.

An embodiment may include a system for displaying data. The system may include a processor, a memory, and one or more modules stored in memory. The one or more modules may be executed by the processor to allocate a memory location in a first database, send a remote direct memory access command from a client to a first database and a second database to write data to the memory location, update an index structure for each of the first database and second database with information regarding the data.

### BRIEF DESCRIPTION OF THE DRAWINGS

FIG. 1 is a system for replicating data.

FIG. 2 is a block diagram of a database server.

FIG. 3 is a method for writing data.

FIG. 4 is a method for reading data.

FIG. 5 provides a computing device for implementing the present technology.

### DETAILED DESCRIPTION

The present technology may provide database replication with low latency using one-sided remote direct memory access. A client may communicate with a DMBS spread across more than one server. The database may include one or more collections of data, known as tables. Each table may be composed of one or more memory data blocks of storage. Memory blocks are either in use storing data, or free for later use. In some DBMSs an in-use block is known as a database row.

Each in-use block may be uniquely identified by a descriptor known as a key. Each table may have an index which may be used to find specific data blocks quickly based on their keys. The index structure may also indicate what data blocks are used and unused. To read the data from a table associated with a certain key, the index structure is accessed to find the specific block containing the data referenced by the key.

After the location is determined, the data is retrieved by reading from the block. After the data is retried, the index must be checked again to see if another client stored a new set of data associated with the key in a different block and updated the index to point to the new block. FI

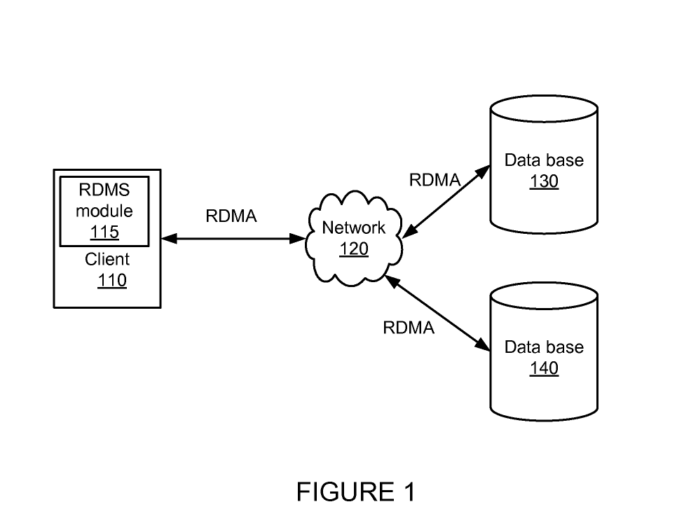

G. 1 is a system for replicating data. The system of FIG. 1 includes database 110, network 120, and servers 130 and 140. Database 110 may be implemented as a computing device capable of accessing data and communicating over network 120, and may be, for example, a desktop, laptop, tablet or other computer, a mobile device of other computing device. Database 110 may communicate with databases 130-140 through network 120.

In some embodiments, database 110 may communicate with the servers by remote direct memory access (RDMA). RDMA is a form direct memory access from the memory of one computer to that of another without involving either computer's operating system. This process of access permits high-throughput, low latency networking.

The system of FIG. 1 may include any application, software module, and process required to implement RDMA communications. For example, RDMA module 115 may reside on database 110. RDMA module 115 may include one or more software modules or processes which may use RDMA to directly perform operations such as read, write and modify the memory of databases 130-140. RDMA module 115 performs operations on database memory without passing control of data access to the operating systems of databases 130-140. Thus, database 110 may access, store and modify data stored in memory at databases 130 and 140 through RDMA. In some embodiments of the invention, the RDMA communications may be one-sided in that database 110 sends RDMA commands to databases 130 and 140, but databases 130-140 do not control access operations and do not send RDMA commands to database 110

Network 120 may communicate with clients 110, server 130 and server 140. Network 120 may be comprised of any combination of a private network, a public network, a local area network, a wide area network, the Internet, an intranet, a Wi-Fi network, a cellular network, or some other network.

Server 130 and 140 may each include one or more servers for storing data. The data may be structured data or unstructured data, and be replicated over the two databases. The memory of each of server 130-140 may be accessible by RDMA module 115 and/or database 110 via RDMA commands.

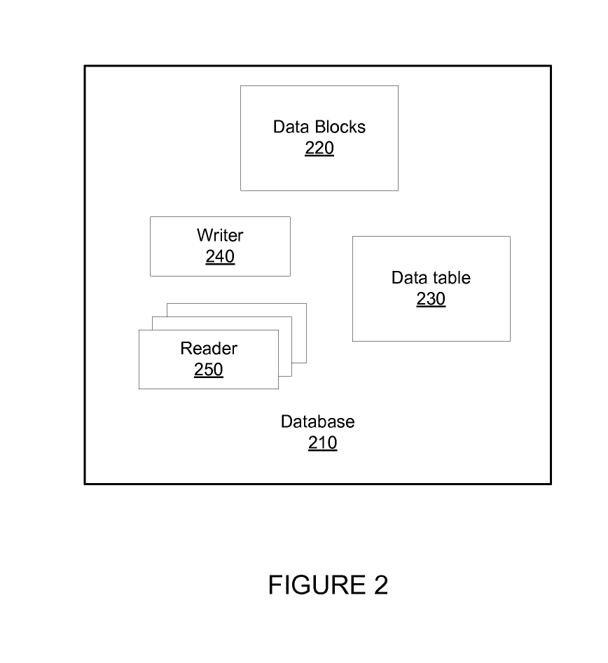

FIG. 2 is a block diagram of a database server. The database server 210 of FIG. 2 includes data blocks 220 and a data table 230. Data blocks 220 may include blocks at which data may be stored, accessed, and modified. The data may be structured or unstructured data. The database server 210 may be used to implement each of databases 130-140 of FIG. 1.

Data table 230 may include an index structure for storing information about data blocks within database 210. In embodiments, the index structure of data table 230 may include pointers to data block locations in memory currently in use. If a particular data block is not being used, the index structure of data table 230 will not include a pointer. In some embodiments, the index structure for data table 230 may be a bit map.

The DBMS may have a management process to coordinate security checks and aiding setting up initial access to the table, such as to data block 220. This helps maintain serialization in writing data from multiple sources.

A writer and reader may exist outside of the DBMS container. Each table in the DBMS can only have one writing client at a time, and may have any number of threads or other reading clients at a time.

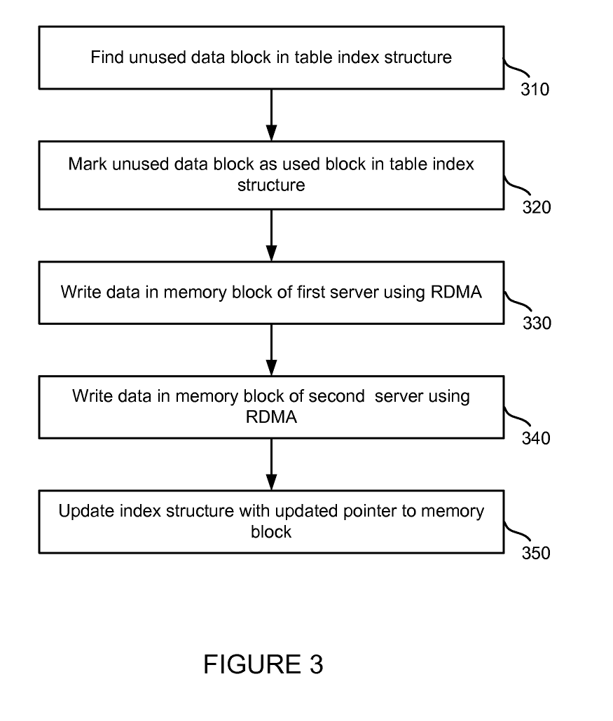

FIG. 3 is a method for writing data. The method of FIG. 3 may be performed by database 110 using RDMA commands sent to one or more of databases 130 and 140. First, an unused data block may be found in a data structure table at step 310. To find the unused data block, database 110 may send an RDMA command to have a read process retrieve the index structure of the data table within the database receiving the request. The index structure will not include pointers for data blocks which are unused.

An unused data block may be marked as a used data block in the index structure of the data table at step 320. To mark a data block in the index structure, database 110 may send an RDMA command to a database write process to update the index structure for a particular data block. The data block that is marked used will be the data block that is being written to by database 110.

Data is written to the memory block of a first server using an RDMA command at step 330. Database 110 may send an RDMA command to the write process to write data to the memory block. By using the RDMA command, database 110 does not involve any processes of the server being written to. Rather, the data is written directly from the memory of database 110 to the memory of the particular data base server. The server has no control over any portion of the process.

Data in the memory block of the second server may be written using RDMA commands at step 340. By writing the data in a memory block of a second server, the data is replicated for durability. The index structure of the tables at each database server is updated at step 350. The update may include adding a pointer to the memory block at which data was just written.

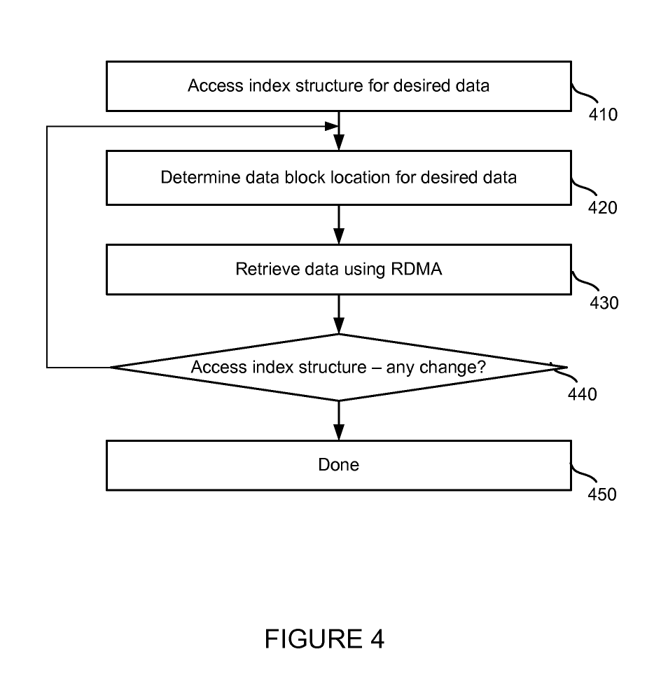

FIG. 4 is a method for retrieving data. The method of FIG. 4 may be performed by database 110 through the use of RDMA commands sent to databases 130 or 140. First, an index structure is accessed for desired data at step 410. The index structure may be accessed by sending an RDMA command to a database. The RDMA command instructs network hardware to do a read from the memory on the server a return the data. Next, a data block location is determined for desired data at step 420. The data block location may be determined from a pointer associated with the desired data in the index structure. Data is retrieved using RDMA commands sent by the client at step 430. The RDMA commands allow the client to retrieve data from a database without ever passing control over the retrieval operation to a particular database.

After receiving the data, the index structure may be accessed again and a determination is made as to whether there is a change in the index structure pointer associated with the memory block read at step 440. If any change occurred between the time when the index structure was first accessed and the time that data was retrieved, the data received by database 110 may not be the most up-to-date data. Therefore, if a change is detected, the method of FIG. 4 returns to step 420 where the data block is retrieved again. If there is no change in the index structure, the retrieved data is up to date and the method of FIG. 4 ends at step 450.

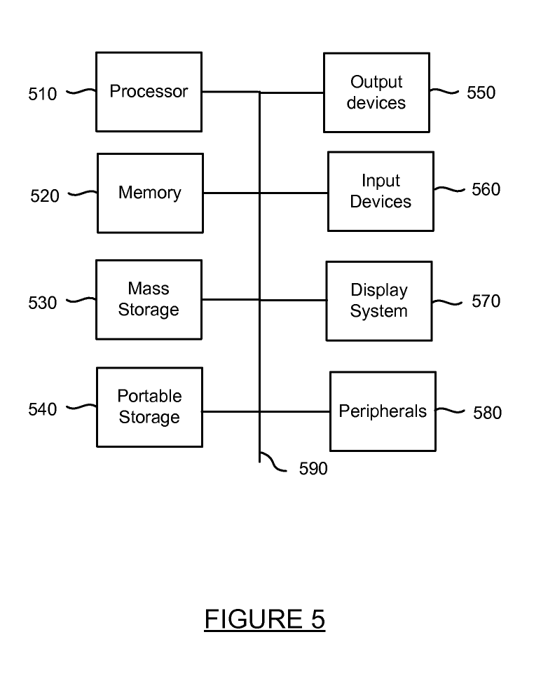

FIG. 5 provides a computing device for implementing the present technology. Computing device 500 may be used to implement devices such as for example data base servers 130 and 140 and database 110. FIG. 5 illustrates an exemplary computing system 500 that may be used to implement a computing device for use with the present technology. System 500 of FIG. 5 may be implemented in the contexts of the likes of client computer 210, servers that comprise services 230-250 and 270-280, application server 260, and data store 267. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a track ball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for replicating data, comprising:
allocating a memory location in a first server;
sending a remote direct memory access command from a client to a first server and a second server to write data to the memory location; and
updating an index structure for each of the first server and second server with information regarding the data.

2. The method of claim 1, wherein allocating includes finding an unused data block in a data structure within each of the first server and the second server.

3. The method of claim 1, wherein allocating includes marking a data block in a data structure within the first server and the second server as used.

4. The method of claim 1, wherein the information regarding the data includes an updated pointer to the memory block.

5. The method of claim 1, wherein the write at the first server memory location does not utilize a server process.

6. The method of claim 1, wherein each index structure is associated with a table, each table associated with a single write client.

7. The method of claim 1, further comprising:
finding desired data in the index structure of one of the first server and the second server;
determining the location of the data from a pointer in the index structure and associated with the data;
retrieving the data using a remote direct memory access command from a client to a first server; and
detecting whether the index structure changed.

8. A computer readable storage medium having embodied thereon a program, the program being executable by a processor to perform a method for replicating data, the method comprising:
allocating a memory location in a first server;
sending a remote direct memory access command from a client to a first server and a second server to write data to the memory location; and
updating an index structure for each of the first server and second server with information regarding the data.

9. The computer readable storage medium of claim 8, wherein allocating includes finding an unused data block in a data structure within each of the first server and the second server.

10. The computer readable storage medium of claim 8, wherein allocating includes marking a data block in a data structure within the first server and the second server as used.

11. The computer readable storage medium of claim 8, wherein the information regarding the data includes an updated pointer to the memory block.

12. The computer readable storage medium of claim 8, wherein the write at the first server memory location does not utilize a server process.

13. The computer readable storage medium of claim 8, wherein each index structure is associated with a table, each table associated with a single write client.

14. The computer readable storage medium of claim 8, the method further comprising:
finding desired data in the index structure of one of the first server and the second server;
determining the location of the data from a pointer in the index structure and associated with the data;
retrieving the data using a remote direct memory access command from a client to a first server; and
detecting whether the index structure changed.

15. A system for displaying data, comprising:
a processor;
memory; and
one or more modules stored in memory and executed by the processor to allocate a memory location in a first server, send a remote direct memory access command from a client to a first server and a second server to write data to the memory location, update an index structure for each of the first server and second server with information regarding the data.

16. The system of claim 15, wherein allocating includes finding an unused data block in a data structure within each of the first server and the second server.

17. The system of claim 15, wherein allocating includes marking a data block in a data structure within the first server as used.

18. The system of claim 15, wherein allocating includes marking a data block in a data structure within the first server and the second server as used.

19. The system of claim 15, wherein the write at the first server memory location does not utilize a server process.

20. The system of claim 15, wherein each index structure is associated with a table, each table associated with a single write client.

21. The system of claim 15, further comprising:
finding desired data in the index structure of one of the first server and the second server;
determining the location of the data from a pointer in the index structure and associated with the data;
retrieving the data using a remote direct memory access command from a client to a first server; and
detecting whether the index structure changed.
